(19) United States
(12) Patent Application Publication
(10) Pub. No.: US 2007/0008863 A1
(43) Pub. Date: Jan. 11, 2007

(54) Memory comprising a memory device and a write unit configured as a probe

(76) Inventors: Corvin Liaw, München (DE); Michael Kund, Tuntenhausen (DE); Gerhard Mueller, München (DE)

Correspondence Address: PATTERSON & SHERIDAN, LLP;Gero McClellan / Infineon Technologies, 3040 POST OAK BLVD.,, SUITE 1500, HOUSTON, TX, 77056, US

(21) Appl. No.: 11/176,740

(22) Filed: Jul. 7, 2005

(51) Int. Cl. G11B 9/00

(52) U.S. Cl. 369/126

(57) ABSTRACT

Embodiments of the present invention provide a method and memory device for storing and reading data. In one embodiment, the probe is positioned proximate to an area of a solid electrolyte layer in which the data is to be stored. A voltage difference is created across the solid electrolyte layer by applying a first voltage to a first side of the solid electrolyte layer via a tip of the probe and applying a second voltage to a second side of the solid electrolyte layer via an electrode layer coupled to the solid electrolyte layer. The voltage difference applied across the solid electrolyte layer causes ions from the electrode layer to be introduced into the solid electrolyte layer, creating a lowered resistance in the solid electrolyte layer. The lowered resistance corresponds to a first logical value stored in the solid electrolyte layer.

### BACKGROUND OF THE INVENTION

1. Field of the Invention

The present invention relates to a memory device and to a write unit configured as a probe, the memory device and the write unit being movable in relation to each other.

2. Description of the Related Art

Steadily increasing demands are made to data memories with regard to the density of information, (i.e., how much information can be stored per unit area), access time, (i.e., how fast a memory element may be accessed), and volatility, (i.e., whether the memory content can be reliably maintained even without supplying energy). In conventional electronic data memories, such as DRAM (dynamic random access memory) or flash RAM, a capacitor typically stores a unit of information. Thus, in storing the unit of information, a distinction may be made between a charged capacitor state and an uncharged capacitor state, these two states representing the possible bits of information “1” and “0”. In some current technologies, in addition to capacitors, additional components, such as selection transistors, may be necessary. Such selection transistors may be created using imaging lithographic processes. Thus, the density of information may be directly limited by the imaging lithographic processes. If smaller structures are to be obtained by means of imaging lithographic processes, light of shorter wavelength is typically used. However, producing of masks as well as the generation of the light itself for the imaging lithographic processes becomes increasingly difficult using short wavelength light.

One method to escape the lithographic limitations in order to increase information density is the use of scanning probes which write and read information at an atomic resolution. Such methods are generally referred to as atomic resolution storage (ARS). Scanning probe tips used in ARS are typically fabricated without the application of imaging techniques.

One scanning probe design which has obtained high write densities is the Millipede concept as described by P. Vettiger et al. in IEEE Trans. Nanotechnol. 1, No. 1, p. 39-55, 2002, hereby incorporated by reference in its entirety. With the Millipede concept, several mechanical probes, adapted from scanning microscopy, are employed to imprint nanoscopic indentations into a polymer film. A “1” or “0” bit information is mechanically defined, depending on whether an indentation is present at a certain position or whether the polymeric film has a smooth surface. The imprinting of the indentations is carried out thermo-mechanically, e.g., the probe is heated and at the same time pressed into the polymer film. Even if the probe is made of a hard material, this method of writing information leads to a certain mechanical stress and to wear of the used probes. With regard to a sufficiently pointed probe for writing sufficiently small indentations and thus densely packed information, the mechanical wear may lead to a limited lifespan of such a memory device.

Information written into the polymer film may be read out by means of the mechanical probe. For instance, the mechanical probe may detect varying heat conduction of the surface. Such varying heat conduction may be dependent on whether an indentation in the polymer film is present or not. This may require the observation of the time-dependent behavior of the electric resistance of a measuring bridge arranged at the tip of the probe. As a result, reading operations may require a minimum time which is determined by the properties of the probe and the polymer.

A further aspect of the memory device concerns erasing and overwriting of already written information. In some cases, relying on a global erasing scheme of the complete memory in a thermo-mechanical memory may be undesirable. In such cases, the Millipede concept offers lateral overwriting, for instance, as described by P. Vettiger et al. in IEEE Trans. Nanotechnol. 1, No. 1, p. 39-55, 2002, hereby incorporated by reference in its entirety. With lateral overwriting, a written indentation may be erased by filling the indentation up with polymeric accumulation resulting from writing a new indentation in close proximity. This may limit the maximum achievable density of information, for example, if every indentation is to be kept erasable.

In addition to mechanical memory devices such as the Millipede memory, electronic concepts as alternatives to DRAMs and flash RAMs are subject to intense research and development activity, in some cases with particular focus on information density and power consumption. For example, in some cases, resistive data memories have been subject to research and development activity. In resistive data memories, a permanent change of resistance in the storage medium may be caused by external signals such as an electric field. The distinction between a high resistive and a low resistive state then defines a “1” or “0” bit information unit.

An example of a resistive data memory is the so-called conductive bridging RAM (CBRAM), in the literature also known as programmable metallization cell RAM (PMC-RAM). The active medium of the CBRAM memory is typically a solid electrolyte into which metal ions can be introduced from a reactive metal layer. The metal then forms a conductive path in the solid electrolyte, thereby increasing the local electric conductivity in the storage medium. The metal ions may be introduced by means of an electric field. Further, the conductive path may be decomposed when the polarity of the electric field is reversed, thus allowing for erasure of the previously written information content.

The technical realization of CBRAM data memories may be carried out similarly to the structuring of capacitors in flash or DRAM data memories, and may be therefore again based on a lithographic definition of the memory elements, for example, as described by R. Symanczyk et al. in Proc. Non-volatile Memory Tech. Symposium, 17-1, 2003, hereby incorporated by reference in its entirety. A memory cell in which an information unit may be stored may be formed, e.g., by the overlapping region of a bit line and a word line and the resistive storage medium, such as a solid electrolyte, arranged in between. Thus, the size of the memory cell may be defined by the width of the conducting lines and a minimum distance between adjacent lines, and thus, again, may be closely linked to lithographic limitations. Furthermore, in some cases, simple integration of resistive storage media into existing highly integrated manufacturing processes may not be always available, since the storage media may be incompatible with individual process steps, particularly steps involving high temperatures.

Accordingly, what is needed is a method of reading and storing data in a memory device which overcome the lithographic limitations of memory with regard to information density.

### SUMMARY OF THE INVENTION

Embodiments of the present invention provide a method and memory device for reading and storing data with a movable probe. In one embodiment of the invention, the probe is positioned proximate to an area of a storage layer in which the data is stored and a voltage difference is created across the storage layer by applying a first voltage to a first side of the storage layer via a tip of the probe and applying a second voltage to a second side of the storage layer via a conductive layer coupled to the storage layer. A logical value of the data is determined based on a current flowing between the storage layer and the tip of the probe generated by application of the voltage difference.

In another embodiment of the invention, the probe is positioned proximate to an area of a solid electrolyte layer in which the data is to be stored. A voltage difference is created across the solid electrolyte layer by applying a first voltage to a first side of the solid electrolyte layer via a tip of the probe and applying a second voltage to a second side of the solid electrolyte layer via an electrode layer coupled to the solid electrolyte layer. The voltage difference applied across the solid electrolyte layer causes ions from the electrode layer to be introduced into the solid electrolyte layer, creating a lowered resistance in the solid electrolyte layer. Creating the lowered resistance corresponds to storing a logical value in the solid electrolyte layer.

Another embodiment of the invention provides a memory device having a storage layer, a conductive layer coupled to a first side of the storage layer, a probe, and control circuitry. The control circuitry is configured to position the probe proximate to an area of a storage layer in which data is stored and create a voltage difference across the storage layer by applying a first voltage to the first side of the storage layer via the conductive layer and applying a second voltage to a second side of the storage layer facing away from the first side via a tip of the probe. A logical value of the data is determined based on a current flowing between the storage layer and the tip of the probe. The current is generated by application of the voltage difference.

Another embodiment of the invention provides a memory device having a solid electrolyte layer, an electrode layer coupled to a first side of the solid electrolyte layer, a probe, and control circuitry. The control circuitry is configured to position the probe proximate to an area of the solid electrolyte layer in which a logical value is to be stored and create a voltage difference across the solid electrolyte layer by applying a first voltage to the first side of the solid electrolyte layer via the electrode layer and applying a second voltage to a second side of the solid electrolyte layer facing away from first side via a tip of the probe. A first voltage difference applied across the solid electrolyte layer causes ions from the electrode layer to be introduced into the solid electrolyte layer, creating a lowered resistance in the solid electrolyte layer. Creating the lowered resistance corresponds to storing a first logical value in the solid electrolyte layer.

Another embodiment of the invention provides a memory device having means for storing, means for conducting coupled to a first side of the means for storing, means for probing, and means for controlling. The means for controlling is configured to position the means for probing proximate to an area of the means for storing in which data is stored and create a voltage difference across the means for storing by applying a first voltage to the first side of the means for storing via the means for conducting and applying a second voltage to a second side of the means for storing facing away from the first side via the means for probing. A logical value of the data is determined based on a current flowing between the means for storing and the means for probing. The current is generated by application of the voltage difference.

Another embodiment of the invention provides a memory device having means for storing, means for conducting coupled to a first side of the means for storing, means for probing, and means for controlling. The means for controlling is configured to position the means for probing proximate to an area of the means for storing in which a logical value is to be stored and create a voltage difference across the means for storing by applying a first voltage to the first side of the means for storing via the means for conducting and applying a second voltage to a second side of the means for storing facing away from first side via the means for probing. The voltage difference applied across the means for storing causes lions from the means for conducting to be introduced into the means for storing, creating a lowered resistance in the means for storing. Creating the lowered resistance corresponds to storing a first logical value in the means for storing.

Another embodiment of the invention provides a method of storing and reading data from a memory device with a movable probe. The method includes storing the data to the memory device and reading the data from the memory device. Storing the data includes positioning the probe proximate to an area of a solid electrolyte layer in which the data is to be stored and creating a first voltage difference across the solid electrolyte layer by applying a first voltage to a first side of the solid electrolyte layer via a tip of the probe and applying a second voltage to a second side of the solid electrolyte layer facing away from the probe via an electrode layer coupled to the solid electrolyte layer. The first voltage difference applied across the solid electrolyte layer causes ions from the electrode layer to be introduced into the solid electrolyte layer, creating a lowered resistance in the solid electrolyte layer. Creating the lowered resistance corresponds to storing a logical value in the solid electrolyte layer. Reading the data from the memory device includes positioning the probe proximate to the area of the solid electrolyte layer in which the data is stored and creating a second voltage difference across the solid electrolyte layer by applying a third voltage to the first side of the solid electrolyte layer via the tip of the probe and applying the second voltage to the second side of the solid electrolyte facing away from the probe via the electrode layer coupled to the solid electrolyte layer. Reading the data also includes determining the logical value of the data based on a current flowing between the solid electrolyte layer and the tip of the probe generated by application of the second voltage difference.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram depicting a memory comprising a memory device and a write unit having a probe according to one embodiment of the invention.

FIG. 2 is a diagram depicting a memory device having a medium with an increased permittivity located between the probe and the active layer, into which the probe may be immersed, according to one embodiment of the invention.

FIG. 3 is a diagram depicting a memory comprising an additional layer between the active layer and the probe for reducing wear on the probe tip according to one embodiment of the invention.

FIG. 4 is a diagram depicting a memory having a medium with an increased permittivity between the active layer and the probe, as well as a layer reducing the mechanical wear of the probe and/or compensating for the mechanical unevenness of the surface of the active layer according to one embodiment of the invention.

FIG. 5 is a diagram depicting a memory having a write unit which comprises several probes according to one embodiment of the invention.

FIG. 6 is a diagram depicting a memory in which the probes are arranged in an array of columns and rows within the write unit and wherein the electrode layer beneath the active layer is divided up into strip-shaped sections according to one embodiment of the invention.

FIG. 7 is a diagram depicting a memory device having probes arranged in an array of columns and rows within the write unit, wherein data stored in the active layer may be accessed by a voltage which may be independently applied to each strip-shaped section of the electrode layer buried beneath the active layer and to each vertical control line according to one embodiment of the invention.

FIG. 8 is a diagram depicting a memory device having probes arranged in an array of columns and rows within the write unit, wherein data stored in the active layer may be written by a voltage which may be independently applied to each strip-shaped section of the electrode layer buried beneath the active layer and to each vertical control line according to one embodiment of the invention.

### DETAILED DESCRIPTION OF THE PREFERRED EMBODIMENT

One embodiment of the present invention provides a memory comprising a memory device and a write unit having at least one probe. In one embodiment of the invention, the memory device and the write unit are movable in relation to each other. The memory device may have an active layer (also referred to as a storage layer), in which the probe may switch at least one storage area (also referred to as a domain or a resistor element) between a high resistive state and a low resistive state by applying electric signals. As a result, a logical state “0” or “1” of an information unit may be assigned, for instance, to the high resistive state and the low resistive state, respectively. Because the domain is read by a moveable probe, the memory may have the advantage of storing information in the active layer without lithographic limitations caused, for example, by circuitry used to read each domain.

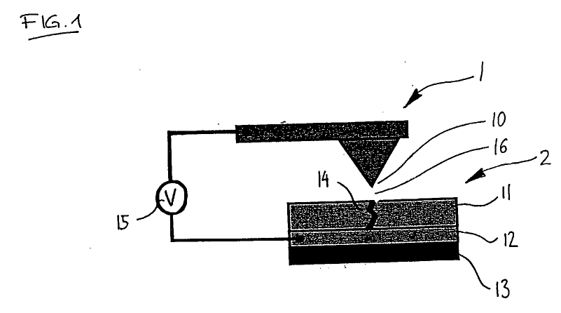

FIG. 1 is a diagram depicting a memory comprising a memory device 2 and a write unit 1 having a probe 10 according to one embodiment of the invention. According to one embodiment, a buried electrode layer 12 may be situated beneath an active layer 11. In some cases, the active layer 11 may comprise a solid electrolyte; however, other suitable material may be utilized. The active layer may also be referred to as a porous resistive ion-conductive active layer. Both the electrode and the active layer may be arranged on a substrate 13. In some cases, the main function of the substrate 13 may also be provided by a sufficiently stable electrode layer.

The electrode layer 12 and active layer 11 on the substrate 13 may be used to store data in the memory. According to one embodiment of the invention, the resistance of the active layer 11 in a given area may be varied by applying an electrical field to the area using the probe 10. Depending on whether the area contains a low resistance or a high resistance, a logical level 1 or a logical level 0 may be stored, respectively. Optionally, a high resistance may correspond to a logical level 1 and a low resistance may correspond to a logical level 0.

In one embodiment, data may be read from a storage area by measuring the resistance of the storage area. For example, the resistance of the storage area may be measured by reading a current caused by a voltage applied to the storage area. In one embodiment, the local electric resistance of the active layer may be determined by using the probe 10 to measure an electric current between the active layer 11. The current may be induced by a voltage difference applied between the probe 10 and the electrode layer 12.

According to one embodiment of the invention, to change the information stored in a storage area, a voltage 15 may be applied between the buried electrode layer 12 and the probe 10. The applied voltage may cause a local change 14 of the electric resistance in the active layer 11 at a corresponding position 16 of the probe 10. Where the active layer 11 comprises a solid electrolyte, the voltage 15 may cause metal ions to migrate from the buried electrode layer 12 into the active layer 11. When the metal ions migrate from the buried electrode layer 12 into the active layer 11, a region of increased electric conductivity 14 (and lowered resistance) may be created. The region of increased electric conductivity 14 may form a metal-rich path, also referred to as a conductive bridging. Thus, by increasing the electric conductivity in the region 14, a logical level 1 may be stored in the region 14.

According to one embodiment of the invention, the metal-rich path 14 may be decomposed (thus decreasing the conductivity and raising the resistance) by reversing the polarity of the voltage 15 and hence leading the ions back into the electrode layer 12. Thus, by decreasing the electric conductivity in the region 14, a logical level 0 may be stored in the region 14, overwriting the previously stored value (logical level 1).

In one embodiment, changes to the conductivity of the region 14 may be persistent in the active layer. In other words, information may be stored and maintained in the memory without supplying energy to the memory (e.g., for instance, to refresh the memory as in a DRAM device). Thus, in some cases, energy consumption of the memory may be reduced.

Thus, according to one embodiment, the region 14 of the electric resistance of the active layer 11 thereby corresponds to an information unit at the position 16 of the probe 10. Since the relative position of the write unit 1 and thus of the probe 10 to the memory device 2 may be changed, the position 16 may be changed for writing or reading a next information unit.

In one embodiment, the probe 10 may be configured in such a way that it may be capable of writing information units into the memory device 2, for example, by means of an electric field or an electric voltage between the probe 10 and the reactive electrode layer 12, as well as being capable of reading out the domains of varying electric resistance contained in the active layer 11 as information units.

In one embodiment, both reading and writing may be performed by means of a current flowing from the reactive electrode layer 12 to the probe 10 via the path 14. A first voltage difference may be applied between the electrode layer 12 and the probe 10 to read data, and a second and third voltage difference may be applied to write a bit or erase a bit, respectively.

In some cases, the probe 10 may make contact with the memory device 2. However, in another embodiment, the probe 10 may be configured in such a way that it can detect or apply electric signals from or to the active layer 11 without being in direct contact to the active layer 11. For example, current may flow via a tunneling barrier between the memory device 2 and the probe 10. Where current flows through a tunneling barrier, the probe 10 may apply or detect the voltage as well as the current without contact to the active layer 11.

In one embodiment, instead of a solid electrolyte, the active layer 11 may comprise other resistive storage media in which the resistance of a section of the active layer 11 may be changed by an electric signal between the electrode layer 12 and the probe 10 at the position 16 of the probe 10. For example, another possibility may include phase change RAM (PCRAM) in which a metal alloy may be heated by means of electric signals, thereby switching between an amorphous and a crystalline phase state. Both states may be characterized by strongly differing resistances which may be used to electrically read-out the memory device 2.

In one embodiment, the active layer 11 may comprise a perovskite cell. The perovskite cell is a resistive storage cell in which a structural transition may be generated between a high resistive and a low resistive state by means of charge injection into a perovskite layer. In one embodiment, the charge injection may be accomplished using a probe 10.

In another embodiment, the active layer may comprise amorphous silicon. Amorphous silicon may be switched between a high resistive and a low resistive state by means of electric signals. In one embodiment, the switching may be accomplished using a probe 10.

In yet another embodiment, polymeric or organic storage layers may be utilized as the active layer 11. For instance, utilizing such materials, different conductivity states may be generated within the active layer 11 on the basis of charge transfer complexes influenced by electric signals. In another embodiment, any suitable material in which the resistance may be varied by means of applying an electrical signal from a probe may be used for the active layer 11.

In some cases, the tip of the probe 10 may influence information density because the size and shape of the tip may determine the size of the storage area in the active layer 11 in which the electric signal applied by the probe may cause a local change of the electric conductivity in the active layer 11. For example, in the case of solid electrolytes, a more pointed probe 10 may generate a denser electric field which in turn results in a path 14 with a smaller cross-section. In the case of other resistive storage media, the configuration of the tip may also influence the density of information, for example, because a pointed probe may not only be capable of generating a locally denser electric field, but also more focused local current densities or heat flux densities, respectively.

In one embodiment, in order to obtain tips which are as pointed as possible, the probe's tip may be drawn out of an etchant in a well defined manner. In another embodiment, a second thinner tip may be grown onto a first tip, for example, by means of an electronic beam deposition. In another embodiment, a second thinner probe tip may be obtained by affixing nanoscopic units, such as carbon nanotubes, to the first tip. In some cases, it may be feasible to manufacture a tip which has only one atom at its very end.

The above-mentioned features and alternative embodiments of the present invention may also be used in conjunction with any of the following embodiments.

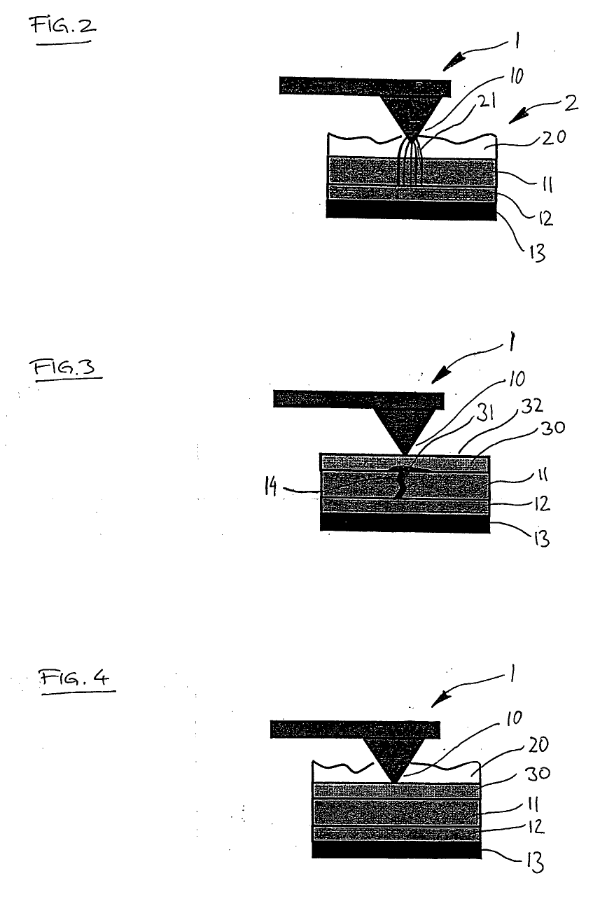

FIG. 2 shows a memory device 2 having a medium 20 with an increased permittivity located between the probe 10 and the active layer 11, into which the probe 10 may be immersed, according to one embodiment of the invention. The increased permittivity of the medium 20 may be higher, for example, than the permittivity of a vacuum. In one embodiment, due to the increased permittivity of the medium 20, the electric field 21 between the probe 10 and the buried electrode layer 12 may be spatially dense (e.g., concentrated), thus resulting in a focused local change of the electric conductivity of the active layer 11 with a smaller cross-section. By reducing the minimum cross-section of an information unit, the total information density of the memory may be increased. Furthermore, in a case where several probes are used, undesired crosstalk between two adjacent probes may be effectively reduced by spatially focusing the electric fields in the medium 20 of increased dielectric permittivity. Similarly, crosstalk between a probe performing a subsequent write and an already-written neighboring probe may be reduced.

In some cases the active layer surface may be uneven. For example, in the case of solid electrolytes, such unevenness of the active layer 11 may be caused by metal precipitates on the surface induced by writing operations. In some cases, the unevenness 31 of the active layer 11 may cause mechanical wear on the probe 10.

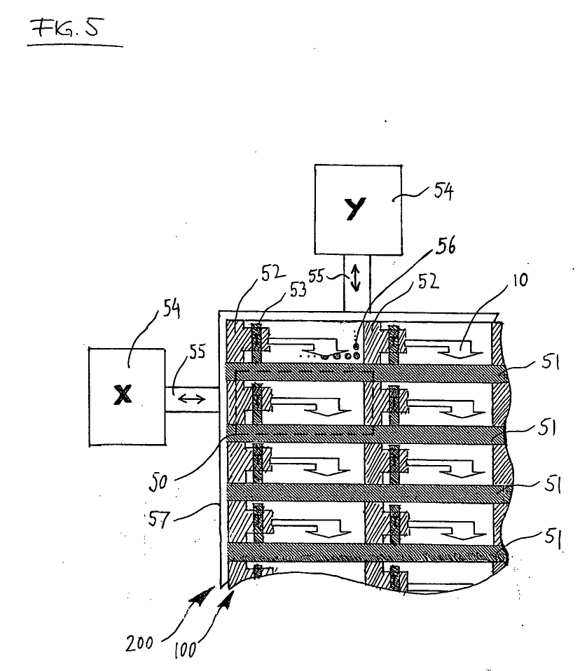

According to one embodiment, an additional layer may be inserted between the probe 10 and active layer 11 to reduce the mechanical wear of the probe. FIG. 3 is a diagram illustrating a memory comprising an additional layer 30 between the active layer 11 and the probe 10 for reducing wear on the probe tip according to one embodiment of the invention. The material 30 may have elastic properties and may be capable of reducing the mechanical wear of the probe 10 and/or compensating for the resulting unevenness 31 of the active layer 11. Thus, in some cases, the layer 30 may be considered a planarization layer providing a planar surface 32 to the probe 10.

FIG. 4 depicts a memory having a medium 20 with an increased permittivity between the active layer 11 and the probe 10, as well as a layer 30 reducing the mechanical wear of the probe 10 and/or compensating for the mechanical unevenness of the surface of the active layer 11, according to one embodiment of the invention. In one embodiment, several or all of the properties described above (e.g., increased permittivity, reduction of mechanical wear, etc.) of the materials located between the active layer 11 and the probe 10 may be provided by a single material. The properties provided by the material may improve the spatial focusing of the electrical field, compensate for surface unevenness of the active layer 11, and reduce the mechanical wear of the probe. Furthermore, in some embodiments, composite materials may also be used as opposed to conventional dielectric materials. For example, the medium may comprise a suspension of a viscous carrier material and solid particles. In this way, several desired properties may be incorporated into a single layer.

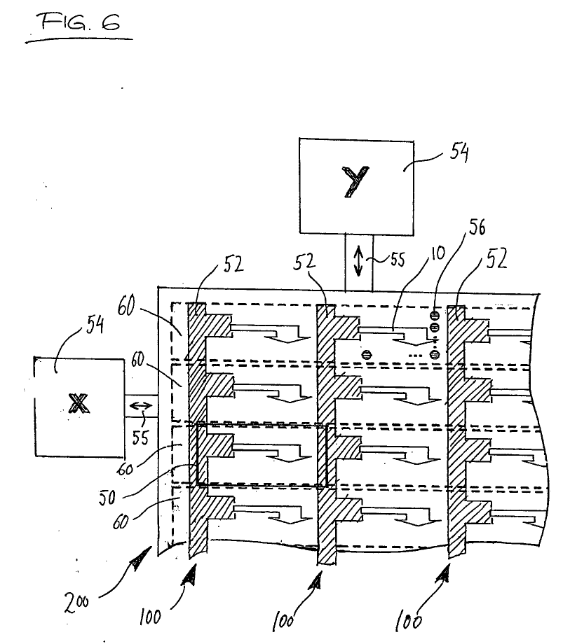

FIG. 5 is a diagram depicting a memory having a write unit 100 which comprises several probes 10 according to one embodiment of the invention. In one embodiment, the probes 10 may be arranged in rows and columns, thus forming an array. Each probe 10 may have a selection transistor 53. The selection transistor 53 may be accessed, for example, by means of an address which, when decoded, selects a vertical line 52 (e.g., a bit line) and a horizontal line 51 (e.g., a word line). As a result, a section 50 of the memory device 200 may be assigned to each probe 10. Each section 50 may be divided up into a sub-array of sections 56, each of which represents an information unit.

In one embodiment, the relative position of the memory device 200 to the write unit 100 (and thus also to the probes 10), may be changed by means of actuators 54 via a mechanical link 55. Thus, the memory device 200 may be moved relative to the write unit 100 and relative to the probe 10, and vice versa. A given information unit 56 may be accessed by using the actuators 54 to position the write unit. The actuators may move the write unit 100 (and thus the probe 10) to a desired horizontal selection line 51 and a desired vertical selection line 52. In some cases, the memory density may be at least in part affected by how precisely the probe can be positioned by the actuators 54.

In the depicted embodiment, the actuators 54 may have a range of motion which is as large as the area of an array element 50. In other words, the actuators 54 may be capable of shifting the position of the write unit 100 such that the shift covers the distance of two adjacent probes. Thus, each probe 10 may be able to access every information unit in a given section 50 of the memory array.

In one embodiment, the actuators 54 may comprise piezo-electric elements which change their extension in a well-defined and reliable manner upon application of a voltage. A variety of such actuators are utilized in the field of micro-electromechanical systems (MEMs) and the field of nano-electromechanical systems (NEMS). Accordingly, configurations of such actuators should be readily apparent to those of ordinary skill in the art.

FIG. 6 is a diagram depicting a memory in which the probes 10 are arranged in an array of columns and rows within the write unit 100 and wherein the electrode layer beneath the active layer is divided up into strip-shaped sections 60 according to one embodiment of the invention. In some cases, as depicted in FIG. 6, a selection transistor may not be required, and access to a probe 10 may be effected by means of the corresponding horizontal section 60 and the associated vertical selection line 52. As described above, the actuators 54 may change the relative position of the memory device 200 to the probes 10 in the region of an array element 50. An individual information unit 56 may be selected and accessed via the corresponding positioning carried out by the actuators 54, the selection of the corresponding section 60, and the selection of the corresponding vertical selection line 52.

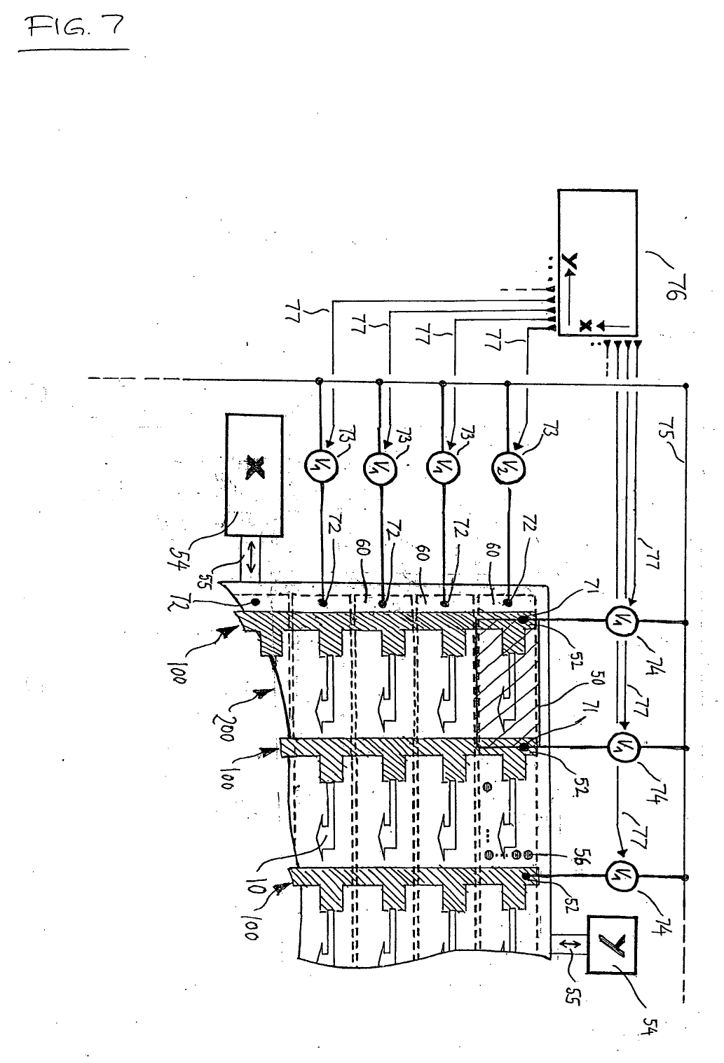

FIG. 7 is a diagram depicting a memory device having probes arranged in an array of columns and rows within the write unit 100, wherein data may be accessed by a voltage which may be independently applied to each strip-shaped section 60 of the electrode layer buried beneath the active layer and to each vertical control line 52 according to one embodiment of the invention. The selection of an information unit 56 within the array element 50 may be carried out by the actuators 54. Each strip-shaped section 60 of the electrode may be contacted by means of a separate contact 72 and a voltage may be applied to each strip-shaped section 60 by means of a horizontal voltage source 73, as well as to each vertical control line 52 via a contact 71 by means of a vertical voltage source 74, all voltage sources 73 and 74 applying voltages in respect to a common ground 75.

In one embodiment, the voltage sources 73 may be addressed individually by control unit 76 via coupling lines 77. Addressing each voltage source 73 individually may allow a single strip-shaped section 60 to be accessed at a time. Where the voltage sources 73 only apply voltage to one of the strip-shaped sections 60 at a time, the remaining sections may have a voltage difference of 0 V, and may thus be deactivated.

In the shown case, all voltage sources 73 and 74 may apply the voltage V₁ with the exception of the top horizontal voltage source 73, which applies V₂. Thus, a finite voltage may be applied only between the probes 10 which are assigned to the top strip-shaped section 60 of the electrode layer. The voltage difference between all the remaining probes 10 and all remaining sections 60 is 0 V (V₁- V₁). Thus, in the shown configuration of the voltage sources 73 and 74, the top section 60 is activated and all probes 10 assigned to the top section 60 may be read out simultaneously. Meanwhile, no voltage may be applied to the remaining sections 60.

In one embodiment, the voltage difference between V₁ and V₂ may be less than a threshold voltage, below which modification of the active layer 10 may not occur. Thus, the voltage difference between V₁ and V₂ may be applied to the probe 10 and a given section 60 to read out data stored in the section without writing to the section 60. Above this threshold voltage, the local resistance of the active layer may be changed, and an information unit 56 may be written or erased.

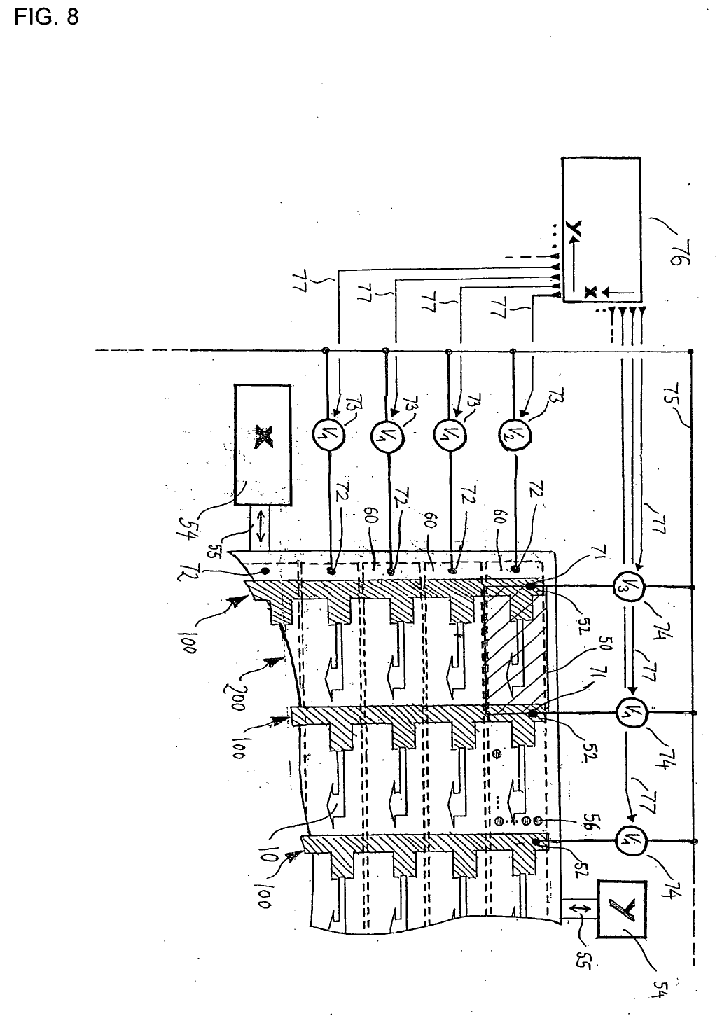

In one embodiment of the invention, as depicted in FIG. 8, each probe 10 may be addressed individually for writing data. For example, to address the probe 10 in the upper-left corner of the write unit depicted in FIG. 8, the first vertical voltage source 74 on the left hand side may apply a voltage V₃. Thus, a voltage difference of V₂ and V₃ may be applied between the top left probe 10 and the top strip-shaped section 60 of the electrode layer. Additionally, a voltage difference of V₁ and V₃ may be applied at all probes below the top-left probe, and a voltage difference between V₁ and V₂ may be applied at all probes on the right hand side of the top-left probe. Thus, the voltage between all remaining probes 10 may be 0 V. In order to select a single probe 10 and to write a single information unit 56 into an array element 50, the voltages V₁, V₂ and V₃ may be biased in a way such that the voltage difference between V₂ and V₃ exceeds the threshold voltage and the voltage differences between V₁ and V₃, and V₁ and V₂, respectively, lie both below the threshold voltage.

The erasure of an information unit 56 in may be similar to a write operation, except the polarity of the applied voltages may be reversed. For example, to erase a single information unit, a voltage of V₁ may be applied to a desired strip-shaped section 60 of the electrode layer using a horizontal voltage source 73 and a voltage of V₂ may be applied to a desired probe 10 using a vertical voltage source 74, both voltage sources 73, 74 being controlled by control unit 76. With respect to the remaining voltage differences in the memory, the voltage difference may be small enough such that no other information is erased.

In one embodiment, a plurality of information units may be erased simultaneously. Simultaneous erasure of information units may be useful, for example, with respect to formatting the entire memory. For example, to format a portion of the memory, a voltage V₁ may be applied by all vertical voltage sources 74, and a voltage V₂ may be applied by all horizontal voltage sources 73, such that the voltage difference between V₁ and V₂ results in an erasure of an information unit 56 within the active layer. In the latter voltage configuration, between each probe 10 and each section 60, a voltage difference between V₁ and V₂ may be applied and all the information units 56 of all array elements 50 at the position of the respective probe 10 may be erased.

In one embodiment, the voltages applied to change the resistive state of the active layer may be varied such that a multiplicity of resistive states may be stored in a single storage area (domain) in the active layer. In other words, it may be possible to reliably define more than two resistive states, e.g., several states of intermediate resistance, and thereby hold more than two logical states in one domain of the active layer. For example, two binary information units, e.g., bits, may be defined by four distinguishable resistive states, such that e.g., “00” corresponds to the highest resistive state and “11” to the lowest resistive states. The values “01” and “10” may be defined by two interstitial resistive states. Thus, the storage density of the memory may be increased.

According to one embodiment of the invention, it may also be possible to substitute the electrode layer for the carrier substrate. In other words, the electrode layer may also serve as the substrate. Thus, in some cases, the memory may be produced with a minimum amount of material and manufacturing processes, while increasing the information density compared to the information density of data memories employing lithographically defined memory cells.

Embodiments of the invention may, in some cases, be integrated with existing CMOS processes. Also, where a scanning probe is utilized with a resistive storage medium, the advantages of both concepts may be efficiently used. For example, in some cases, lithographical limitations and manufacturing difficulties associated with conventional resistive data storage may be overcome. In addition, in some cases, some disadvantages of probe-assisted memories, such as complex read and erasure procedures, may be circumvented. Also, in some cases, a significantly simpler production method may be provided.

In one embodiment of the invention, where multiple probes are used, the probes may simultaneously and independently apply electric signals to the active layer. By simultaneously and independently applying electrical signals to the active layer, read and write accesses to the storage medium may be carried out simultaneously at different positions.

While the foregoing is directed to embodiments of the present invention, other and further embodiments of the invention may be devised without departing from the basic scope thereof, and the scope thereof is determined by the claims that follow.

What is claimed is:

1. A method for reading data from a memory device with a movable probe, the method comprising:
positioning the probe proximate to an area of a storage layer in which the data is stored;
creating a voltage difference across the storage layer by applying a first voltage to a first side of the storage layer via a tip of the probe and applying a second voltage to a second side of the storage layer via a conductive layer coupled to the second side of the storage layer; and
determining a logical value of the data based on a current flowing between the area of the storage layer and the tip of the probe generated by application of the first and second voltages.

2. The method of claim 1, wherein a first amount of current flow corresponds to a first logical value stored in the area and a second amount of current flow corresponds to a second logical value stored in the area.

3. The method of claim 2, wherein a third amount of current flow corresponds to a third logical value stored in the area and a fourth amount of current flow corresponds to a fourth logical value stored in the area.

4. The method of claim 1, wherein the tip of the probe is positioned in direct contact with the area of the storage layer.

5. The method of claim 1, wherein the tip of the probe comprises a carbon nanotube.

6. The method of claim 1, wherein the storage layer comprises a solid electrolyte.

7. A method for storing data to a memory device, comprising:
positioning a probe proximate to an area of a solid electrolyte layer in which data is to be stored; and
creating a voltage difference across the solid electrolyte layer by applying a first voltage to a first side of the solid electrolyte layer via a tip of the probe and applying a second voltage to a second side of the solid electrolyte layer via an electrode layer coupled to the solid electrolyte layer, wherein the voltage difference across the solid electrolyte layer causes ions from the electrode layer to be introduced into the solid electrolyte layer, creating a lowered resistance in the solid electrolyte layer, wherein creating the lowered resistance corresponds to storing a logical value in the solid electrolyte layer.

8. The method of claim 7, wherein the tip of the probe comprises a carbon nanotube.

9. The method of claim 7, wherein a layer of material between the tip of the probe and the solid electrolyte layer reduces wear on the tip of the probe as the tip of the probe is positioned with respect to the solid electrolyte layer.

10. The method of claim 7, wherein a layer of dielectric material is situated between the tip of the probe and the solid electrolyte layer.

11. The method of claim 7, wherein the electrode layer is a substrate of the memory device.

12. A memory device, comprising:
a storage layer;
a conductive layer coupled to a first side of the storage layer;
a probe; and
control circuitry configured to:
position the probe proximate to an area of a storage layer in which data is stored;
create a voltage difference across the storage layer by applying a first voltage to the first side of the storage layer via the conductive layer and applying a second voltage to a second side of the storage layer facing away from the first side via a tip of the probe; and
determine a logical value of the data based on a current flowing between the storage layer and the tip of the probe, wherein the current is generated by application of the first and second voltages.

13. The memory device of claim 12, wherein a first amount of current flow corresponds to a first logical value stored in the area and a second amount of current flow corresponds to a second logical value stored in the area.

14. The memory device of claim 12, wherein the storage layer comprises one of a solid electrolyte, a metal alloy having an amorphous states and a crystalline state, a perovskite cell, and amorphous silicon.

15. The memory device of claim 12, wherein the probe is one a plurality of probes arranged in an array on the memory device, wherein the control circuitry simultaneously and independently controls a voltage applied by each probe in the array.

16. The memory device of claim 12, wherein the probe is one of a plurality of probes arranged in an array, wherein the electrode layer is one of a plurality of strips of electrode, wherein the data is located in a section of the array in which the respective probe is positioned, and wherein the data is read by applying the first voltage to the respective strip and applying the second voltage to a vertical selection line for the respective probe, wherein the second voltage is applied to other strips of the plurality of strips.

17. A memory device, comprising:
a solid electrolyte layer;
an electrode layer coupled to a first side of the solid electrolyte layer;
a probe; and
control circuitry configured to:
position the probe proximate to an area of the solid electrolyte layer in which a logical value is to be stored; and
create a first voltage difference across the solid electrolyte layer by applying a first voltage to the first side of the solid electrolyte layer via the electrode layer and applying a second voltage to a second side of the solid electrolyte layer facing away from first side via a tip of the probe:
wherein the first voltage difference across the solid electrolyte layer causes ions from the electrode layer to be introduced into the solid electrolyte layer, creating a lowered resistance in the solid electrolyte layer, wherein creating the lowered resistance corresponds to storing a first logical value in the solid electrolyte layer.

18. The memory device of claim 17, further comprising:
applying a second voltage difference across the solid electrolyte layer, the second voltage creating an increased resistance in the solid electrolyte layer, wherein creating an increased resistance corresponds to storing a second logical value the solid electrolyte layer;
applying a third voltage difference across the solid electrolyte layer, the third voltage creating a first intermediate resistance in the solid electrolyte layer corresponding to a third logical value being stored in the solid electrolyte layer; and
applying a fourth voltage difference across the solid electrolyte layer, the fourth voltage difference creating a second intermediate resistance in the solid electrolyte layer corresponding to a fourth logical value being stored in the solid electrolyte layer.

19. The memory device of claim 17, wherein the tip of the probe is in direct contact with the area of the solid electrolyte layer.

20. The memory device of claim 17, wherein the tip of the probe comprises a carbon nanotube.

21. The memory device of claim 17, wherein the electrode layer is a substrate of the memory device.

22. The memory device of claim 17, wherein the probe is one a plurality of probes arranged in an array on the memory device.

23. A memory device, comprising:
storing means;
conducting means coupled to a first side of the storing means;
probing means; and
controlling means configured to:
position the probing means proximate to an area of the storing means in which data is stored; and
create a voltage difference across the storing means by applying a first voltage to the first side of the storing means via the conducting means and applying a second voltage to a second side of the storing means facing away from the first side via the probing means.

24. The memory device of claim 23, wherein the controlling means is further configured to:
determine a logical value of the data based on a current flowing between the storing means and the probing means, wherein the current is generated by application of the first and second voltages.

25. The memory device of claim 23, wherein the voltage difference across the storing means causes ions from the conducting means to be introduced into the storing means, creating a lowered resistance in the storing means, wherein creating the lowered resistance corresponds to storing a first logical value in the storing means.

26. A method for storing and reading data from a memory device with a movable probe, the method comprising:
storing the data to the memory device, wherein storing the data comprises:
positioning the probe proximate to an area of a solid electrolyte layer in which the data is to be stored; and
creating a first voltage difference across the solid electrolyte layer by applying a first voltage to a first side of the solid electrolyte layer via a tip of the probe and applying a second voltage to a second side of the solid electrolyte layer facing away from the probe via an electrode layer coupled to the solid electrolyte layer:
wherein the first voltage difference applied across the solid electrolyte layer causes ions from the electrode layer to be introduced into the solid electrolyte layer, creating a lowered resistance in the solid electrolyte layer, wherein creating the lowered resistance corresponds to storing a logical value in the solid electrolyte layer; and
reading the data from the memory device, wherein reading the data comprises:
positioning the probe proximate to the area of the solid electrolyte layer in which the data is stored;
creating a second voltage difference across the solid electrolyte layer by applying a third voltage to the first side of the solid electrolyte layer via the tip of the probe and applying the second voltage to the second side of the solid electrolyte facing away from the probe via the electrode layer coupled to the solid electrolyte layer; and
determining the logical value of the data based on a current flowing between the solid electrolyte layer and the tip of the probe generated by application of the second voltage difference.
